(19) United States
(12) Patent Application Publication
(10) Pub. No.: US 2011/0260850 A1
(43) Pub. Date: Oct. 27, 2011

(54) DISPLAY DEVICE

(75) Inventor: Joffrey Ringenwald, Strasbourg (FR)

(73) Assignee: Johnson Control Technology Company

(21) Appl. No.: 13/057,659

(22) PCT Filed: Jul. 21, 2009
(86) PCT No.: PCT/EP09/05271

§ 371 Date: Jul. 12, 2011

(30) Foreign Application Priority Data
Aug. 13, 2008 (DE) 10 2008 038 974.9
Jan. 29, 2009 (DE) 10 2009 006 658.6

(51) Int. Cl. G09F 9/00

(52) U.S. Cl. 340/461

(57) ABSTRACT

A display device for a motor vehicle comprises only a single pointer and two scales. The scales may indicate, with the pointer, vehicle speed and engine rotational speed. At least one of the scales may be dynamic. Scaling may indicate available gears in segments, and the segments may be illuminated. Illumination may vary in length and an illuminated surface and/or intensity may be a function of engine speed.

### CROSS REFERENCE TO RELATED APPLICATIONS

This application claims priority from and the benefit of PCT Application No. PCT/EP2009/005271, filed on Jul. 21, 2009; German Patent No. DE 10 2008 038 974.9, filed on Aug. 13, 2008; and German Patent DE 10 2009 006 658.6, filed on Jan. 29, 2009; all entitled “DISPLAY DEVICE”, which are herein incorporated by reference.

### BACKGROUND

The invention relates to a display device for use in the automobile field.

Motor vehicle display instruments with a pointer that moves over a scale as a function of a measured variable to be displayed are present on the market in numerous configurations.

Furthermore, it is known to display the vehicle speed by using a display instrument operating in analog fashion, and another, independent display instrument for displaying the engine speed.

In view of the area of conflict between, on the one hand, the information provided to the driver, which is growing steadily in modern motor vehicles, and, on the other hand, the very limited space available in vehicles for display instruments in the driver's field of view, it is the object of the invention to provide a novel display device in which the space requirement is reduced by comparison with the prior art.

### SUMMARY

The object is achieved with the aid of a display device of a motor vehicle having only a single pointer, said device having two scales.

The present invention relates to a display device of a motor vehicle that has only a single pointer, but two scales. It is thereby possible to display two measured values with the aid of one display device, thus rendering it possible to design the display device smaller overall. The two measured values are displayed in analog fashion. The measured values are preferably the speed of the vehicle and the engine speed.

It is preferred for the pointer together with the second scaling to display a first measured value, for example the speed of the motor vehicle.

Furthermore, the pointer together with the first scaling preferably displays a second measured value, for example the engine speed of the motor vehicle. It is particularly preferred in this case for the scaling of the first scale to vary dynamically such that the pointer simultaneously displays correct first and second measured values. This variation of the scaling can be performed by varying the scale values and/or by moving, for example rotating the scale.

The first scaling preferably has segments, the number of which correspond to the number of the available gears of the gearshift of the vehicle, the length of the respective segment corresponding to the permissible or recommended rotational speed. The driver of the vehicle detects from the interplay of the pointer with the respective segment whether the engine is rotating at a low, middle or high speed. The respective segments preferably differ in their length. Furthermore, the segments are preferably respectively, with particular preference individually capable of being illuminated. It is preferred for only the segment which corresponds to that gear of the gearshift just selected to be illuminated. In another preferred embodiment, the number of the illuminated segments corresponds to the number of the selected gear of the gearshift. During a drive in second gear, the first and second segment are therefore illuminated.

In a further preferred embodiment of the present invention, the illuminated surface and/or the intensity of the illumination of the respective segment is a function of the engine speed. This preferred embodiment of the present invention enables a display of a measured value, for example a rotational speed without the aid of the pointer. Moreover, with the aid of this preferred embodiment it is possible to issue a warning alert, for example by having the segment light up very brightly or flash when the recommended speed range is left. The type of illumination can also depend on the instantaneous energy consumption.

In another preferred embodiment, the first scaling has illuminated areas, the number of the illuminated areas corresponding to the engine speed.

The invention has the advantage that there is simultaneously provided in the display area of a display instrument displaying, for example, the vehicle speed in analog fashion an analog display means for the engine speed, for example.

### DRAWINGS

Embodiments of the invention that are to be considered purely as exemplary are further described in somewhat more detail below with reference to the attached drawings.

FIG. 1 is a schematic plan view of a display area of a first type of display device configured according to the invention;

FIG. 2 is a schematic plan view of a display area of a second type of display device configured according to the invention;

FIG. 3 is a schematic plan view of a display area of a third type of display device configured according to the invention; and

FIG. 4 is a schematic plan view of a display area of a fourth type of display device configured according to the invention.

### DETAILED DESCRIPTION

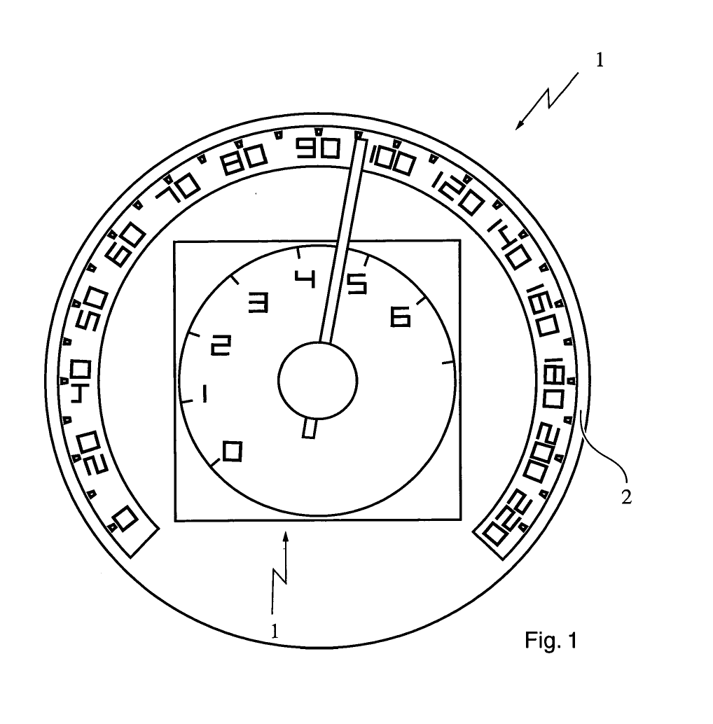

FIG. 1 is a schematic of a plan view of a display area of a first type of display device A configured in accordance with the invention. The inventively configured display device A comprises a second scale 2 for the vehicle speed and an electronic display. A first scale 1, dynamically displayed on the display, for the engine speed is rescaled relative to the various gear ratios in the case of the inventively configured display device A. Since the values for the vehicle speed and the engine speed are related to one another by the gear ratio, it follows that on each occasion a pointer 3 displays the current value of the vehicle speed on the second scale 2, and the current value of the engine speed on the first scale 1, doing so simultaneously. The image of the pointer 3 and of the second scale 2 for the vehicle speed can likewise be displayed on the display.

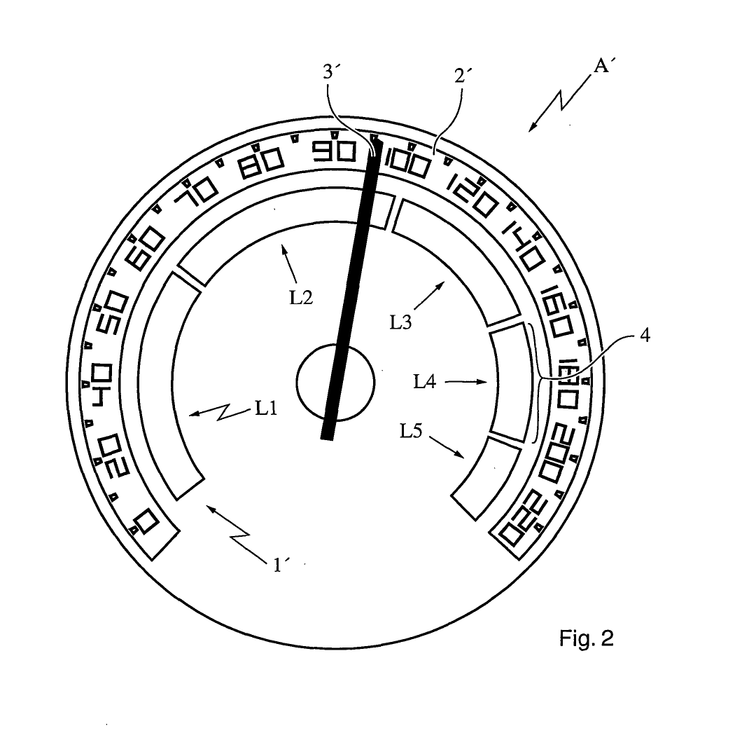

FIG. 2 is a schematic plan view of a display area of a second type of display device A′ configured according to the invention. The inventively configured display device A′ comprises anew a second scale 2′ for the vehicle speed and a pointer 3′ that, by its position on the second scale 2′, displays the current vehicle speed.

In order to display the engine speed, the inventively configured display device A′ has an analog display means in the form of a plurality of first illuminated areas L1, L2, L3, L4, L5 that are arranged offset from one another on a circle and in each case take the form of an annular segment. The first illuminated areas L1, L2, L3, L4, L5 are illuminated in accordance with the gear selected. In the present case, the motor vehicle is driving in second gear. Were a switch made to the third gear, a further segment would light up. The driver of the vehicle recognizes from the interplay between the pointer and the respective segment whether the engine is rotating at a low, middle or high speed. In the present case, the motor vehicle is driving in second gear at a speed that is at the other end of the recommended range. If the pointer is located outside the segment corresponding to the selected gear, the engine is rotating outside the recommended range. The length 4 of the respective segment differs. The first scale 1′ for the engine speed is, for example, applied to the application of the combination instrument.

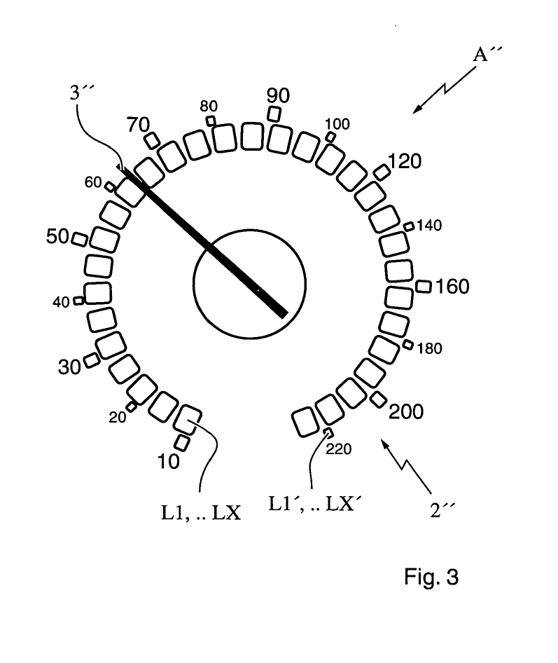

FIG. 3 is a schematic plan view of a display area of a third type of inventively configured display device A″.

The inventively configured display device A″ comprises, in turn, a second scale 2′, for the vehicle speed and a pointer 3″ the position of which on the second scale 2″ displays the current vehicle speed. In order to display the engine speed, the inventively configured display device A″ has analog display means in the form of a plurality of second illuminated areas L1′, L2′, L3′, . . . LX′ which are arranged offset from one another on a circle and respectively have a rectangular shape here. These second illuminated areas L1′-LX′ are switched on and off by a control such that they form a chain, which grows with increasing engine speed, of light sources which light up. The second areas L1′-LX′ are preferably backlit in at least two different colors in order thus to inform the driver of the current engine efficiency by means of a color code. As shown in FIG. 3, the numerical values for the vehicle speed can be arranged in the area of the second scale.

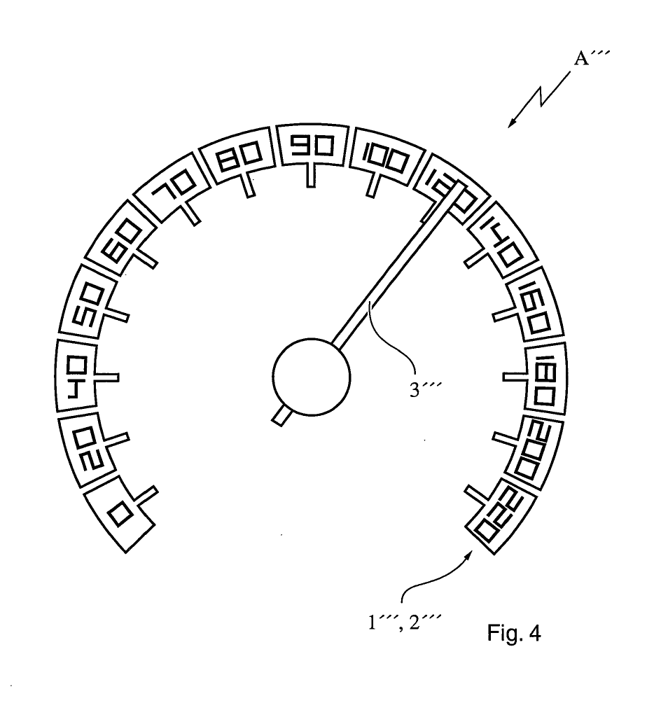

FIG. 4 is a schematic plan view of a display area of a fourth type of inventively configured display device A′″. The inventively configured display device A′″ comprises in turn a second scale 2′″ for the vehicle speed and a pointer 3′″ the position of which on the second scale 2′″ displays the current vehicle speed. This is 120 km/h at the moment. In the present case, the first scale is lighting means with the aid of which the segments of the second scale can be backlit so that they have a different color from the remaining segments. In the present case, the segments 0-80 are illuminated, which means that the engine is rotating in its upper permissible speed range. In essence, the embodiment in accordance with FIG. 4 therefore corresponds to the embodiment in accordance with FIG. 3, except that in the present case the segments L1-LX and L1′-LX′ are superposed.

### LIST OF REFERENCE SYMBOLS

A Display device of a first type
A′ Display device of a second type
A″ Display device of a third type
A′″ Display device of a fourth type
1 first scale
2, 2′, 2″, 2′″ Second scale
3, 3′, 3″, 3′″ Pointer
L1, L2, L3, L4, L5 First illuminated areas
L1′, L2′, L3′, L4′, L5′, LX′ Second illuminated areas
4 Length of the segments L1-L5

1. A display device of a motor vehicle comprising only a single pointer, wherein the display further comprises two scales.

2. The display device as claimed in claim 1, wherein the pointer together with a second of the scales indicates a first measured value.

3. The display device as claimed in claim 2, wherein the pointer together with a first of the scales displays a second measured value.

4. The display device as claimed in claim 3, wherein scaling of the first scale varies dynamically.

5. The display device as claimed in claim 4, wherein the first scaling has segments, the number of which corresponds to the number of the available gears of the vehicle.

6. The display device as claimed in claim 5, wherein the respective segments differ in their length.

7. The display device as claimed in claim 5, wherein the segments are capable of being illuminated.

8. The display device as claimed in claim 7, wherein a respectively illuminated surface of each segment and/or the intensity of the illumination of the respective segment is a function of the engine speed.

9. The display device as claimed in claim 1, wherein at least one of the scales has illuminated areas.

10. The display device as claimed in claim 2, wherein the second scale indicates speed of the motor vehicle.

11. The display device as claimed in claim 3, wherein the first scale indicates engine speed.

12. The display device as claimed in claim 4, wherein the length of each segment corresponds to permissible rotational speed.

13. The display device as claimed in claim 7, wherein the segments are capable of being illuminated individually.

14. The display device as claimed in claim 9, wherein the number of illuminated areas corresponds to engine speed.
